(19) United States
(12) Patent Application Publication
(10) Pub. No.: US 2011/0194746 A1
(43) Pub. Date: Aug. 11, 2011

(54) Method for Time-of-Arrival Mapping in Magnetic Resonance Imaging

(76) Inventor: Stephen J. Riederer, Rochester, MN (US)

(21) Appl. No.: 13/122,879

(22) PCT Filed: Sep. 28, 2009
(86) PCT No.: PCT/US09/58587

§ 371 Date: Apr. 6, 2011

Related U.S. Application Data
(60) Provisional application No. 61/195,974, filed on Oct. 14, 2008.

(51) Int. Cl. G06K 9/00

(52) U.S. Cl. 382/131

(57) ABSTRACT

A method for producing an image indicative of the time-of-arrival of contrast agent in a tissue of interest is provided. More specifically, a time-of-arrival is calculated for each voxel location in a time series of magnetic resonance (MR) images. The accuracy of the time-of-arrival presentation is enhanced when the underlying MR image acquisition is consistent, is done with compact sampling of the k-space center, has minimal temporal footprint for each image, and has a negligible anticipation artifact. The time-of-arrival presentation can be further enhanced by the suppression of signals from background tissue by using, for example, thresholding or by conversion of the time-of-arrival information into a color scale.

### CROSS-REFERENCE TO RELATED APPLICATIONS

This application claims the benefit of U.S. Provisional patent application Ser. No. 61/195,974 filed on Oct. 14, 2008, and entitled “Method for Time of Arrival Mapping in Magnetic Resonance Imaging.”

### STATEMENT REGARDING FEDERALLY SPONSORED RESEARCH

This invention was made with United States government support awarded by the following agency: National Institutes of Health, NIH EB000212. The United States has certain rights in this invention.

### BACKGROUND OF THE INVENTION

The field of the invention is magnetic resonance imaging (“MRI”) methods and systems. More particularly, the invention relates to contrast enhanced MRI.

When a substance such as human tissue is subjected to a uniform magnetic field (polarizing field B₀), the individual magnetic moments of the nuclei in the tissue attempt to align with this polarizing field, but precess about it in random order at their characteristic Larmor frequency. If the substance, or tissue, is subjected to a magnetic field (excitation field B₁) that is in the x-y plane and that is near the Larmor frequency, the net aligned moment, M_{Z}, may be rotated, or “tipped,” into the x-y plane to produce a net transverse magnetic moment M_{xy}. A signal is emitted by the excited nuclei or “spins,” after the excitation signal B₁ is terminated, and this signal may be received and processed to form an image.

When utilizing these “MR” signals to produce images, magnetic field gradients (Gₓ, G_{y}, and G_{z}) are employed. Typically, the region to be imaged is scanned by a sequence of measurement cycles in which these gradients vary according to the particular localization method being used. The resulting set of received MR signals are digitized and processed to reconstruct the image using one of many well known reconstruction techniques.

The measurement cycle used to acquire each MR signal is performed under the direction of a pulse sequence produced by a pulse sequencer. Clinically available MRI systems store a library of such pulse sequences that can be prescribed to meet the needs of many different clinical applications. Research MRI systems include a library of clinically-proven pulse sequences and they also enable the development of new pulse sequences.

The MR signals acquired with an MRI system are signal samples of the subject of the examination in Fourier space, or what is often referred to in the art as “k-space”. Each MR measurement cycle, or pulse sequence, typically samples a portion of k-space along a sampling trajectory characteristic of that pulse sequence. Most pulse sequences sample k-space in a raster scan-like pattern sometimes referred to as a “spin-warp,” a “Fourier,” a “rectilinear,” or a “Cartesian” scan. The spin-warp scan technique employs a variable amplitude phase encoding magnetic field gradient pulse prior to the acquisition of MR spin-echo signals to phase encode spatial information in the direction of this gradient. In a two-dimensional implementation (“2DFT”), for example, spatial information is encoded in one direction by applying a phase encoding gradient, G_{y}, along that direction, and then a spin-echo signal is acquired in the presence of a readout magnetic field gradient, Gₓ, in a direction orthogonal to the phase encoding direction. The readout gradient present during the spin-echo acquisition encodes spatial information in the orthogonal direction. In a typical 2DFT pulse sequence, the magnitude of the phase encoding gradient pulse, G_{y}, is incremented, ΔG_{y}, in the sequence of measurement cycles, or “views” that are acquired during the scan to produce a set of k-space MR data from which an entire image can be reconstructed.

There are many other k-space sampling patterns used by MRI systems. These include “radial,” or “projection reconstruction,” scans in which k-space is sampled as a set of radial sampling trajectories extending from the center of k-space. The pulse sequences for a radial scan are characterized by the lack of a phase encoding gradient and the presence of a readout gradient that changes direction from one pulse sequence view to the next. There are also many k-space sampling methods that are closely related to the radial scan and that sample along a curved k-space sampling trajectory rather than the straight line radial trajectory.

Magnetic resonance angiography (“MRA”) uses the magnetic resonance phenomenon to produce images of the human vasculature. To enhance the diagnostic capability of MRA a contrast agent such as gadolinium can be injected into the patient prior to the MRA scan. The trick with this contrast enhanced (“CE”) MRA method is to acquire the central k-space views at the moment the bolus of contrast agent is flowing through the vasculature of interest. Collection of the central lines of k-space during peak arterial enhancement is key to the success of a CE-MRA exam. If the central lines of k-space are acquired prior to the arrival of contrast, severe image artifacts can limit the diagnostic information in the image. Alternatively, arterial images acquired after the passage of the peak arterial contrast are sometimes obscured by the enhancement of veins. In many anatomic regions, such as the carotid or renal arteries, the separation between arterial and venous enhancement can be as short as 6 seconds.

The short separation time between arterial and venous enhancement dictates the use of acquisition sequences of either low spatial resolution or very short repetition times (“TR”). Short TR acquisition sequences severely limit the signal-to-noise ratio (“SNR”) of the acquired images relative to those exams in which the use of a longer TR is possible. Thus, the rapid acquisitions required by first pass CE-MRA methods impose an upper limit on either spatial or temporal resolution.

As indicated above, the acquisition of MRA data is timed such that the central region of k-space is acquired as the bolus of contrast agent arrives in the arteries of interest. The ability to time the arrival of contrast varies considerably and it is helpful in many applications where proper timing is difficult to acquire a series of MRA image frames in a dynamic study that depicts the separate enhancement of arteries and veins. Such temporal series of image frames is also useful for observing delayed vessel filling patterns caused by disease. This requirement has been partially addressed by acquiring a series of time resolved images using a 3D “Fourier” acquisition as described by F. Korosec, at al., in “Time-Resolved Contrast-Enhanced 3D MR Angiography,” Magn. Reson. Med., 1996; 36:345-351, and in U.S. Pat. No. 5,713,358. When a dynamic study is performed the time resolution of the study is determined by how fast the k-space data can be acquired for each image frame. This time resolution objective is often compromised in order to acquire all the k-space data needed to produce image frames of a prescribed resolution without undersampling artifacts.

It would therefore be desirable to provide a method for producing an image of the vasculature of a subject that allows an increase in the discrimination between arteries and veins. Such a method would desirably allow for the generation of images indicative of both arteries and veins, images indicative of arteries alone, and images indicative of veins alone, all from the same set of acquired image data.

### SUMMARY OF THE INVENTION

The present invention provides a method for producing an image indicative of the time-of-arrival of contrast agent in a tissue of interest. More specifically, a time-of-arrival is calculated for each voxel location in a time series of magnetic resonance (“MR”) images. The accuracy of the time-of-arrival presentation is enhanced when the underlying MR image acquisition is consistent, is done with compact sampling of the k-space center, and has minimal temporal footprint for each image and negligible anticipation artifact. The time-of-arrival presentation can be further enhanced by suppression of signals from background tissue by using, for example, thresholding or by conversion of the time-of-arrival information into a color scale.

The foregoing and other aspects and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims and herein for interpreting the scope of the invention.

### BRIEF DESCRIPTION OF THE DRAWINGS

FIG. 1 is a block diagram of a magnetic resonance imaging (“MRI”) system that employs the present invention;

FIG. 2 is a graphic representation of an exemplary pulse sequence employed by the MRI system of FIG. 1 in performing an exemplary method for producing a map of the time-of-arrival of a contrast agent in a subject;

FIG. 3 is an exemplary plot of a signal intensity change at a voxel location during the passage of a contrast agent through the voxel location;

FIG. 4 is a graphic representation of an exemplary elliptical centric view order k-space sampling pattern;

FIG. 5 is a flowchart setting forth the steps of an exemplary method for producing a time-of-arrival map, which is indicative of the time at which a contrast agent arrived in a tissue-of-interest in a subject;

FIG. 6 is a flowchart setting forth the steps of an exemplary method for determining the time-of-arrival of a contrast agent passing through a tissue-of-interest at a voxel location in a time series of images;

FIG. 7 is a flowchart setting forth the steps of another exemplary method for determining the time-of-arrival of a contrast agent passing through a tissue-of-interest at a voxel location in a time series of images; and

FIG. 8 is an exemplary plot of a signal intensity change for arterial and venous phases of the passage of a contrast agent through a tissue of interest in a subject.

### DETAILED DESCRIPTION OF THE INVENTION

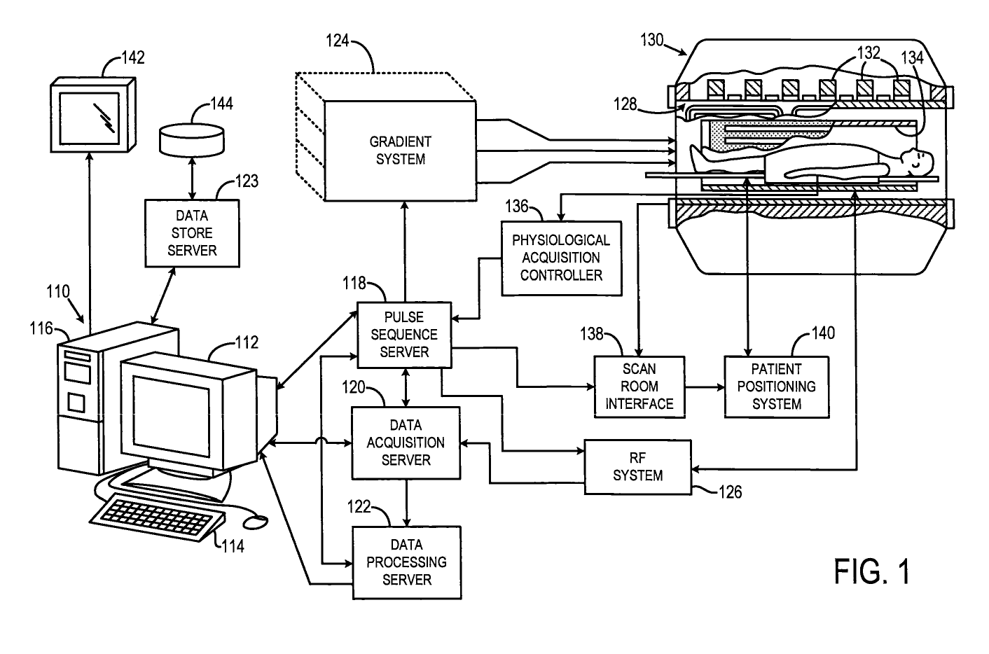

Referring particularly to FIG. 1, the preferred embodiment of the invention is employed in a magnetic resonance imaging (“MRI”) system. The MRI system includes a workstation 110 having a display 112 and a keyboard 114. The workstation 110 includes a processor 116 that is a commercially available programmable machine running a commercially available operating system. The workstation 110 provides the operator interface that enables scan prescriptions to be entered into the MRI system. The workstation 110 is coupled to four servers: a pulse sequence server 118; a data acquisition server 120; a data processing server 122, and a data store server 123. The workstation 110 and each server 118, 120, 122 and 123 are connected to communicate with each other.

The pulse sequence server 118 functions in response to instructions downloaded from the workstation 110 to operate a gradient system 124 and a radiofrequency (“RF”) system 126. Gradient waveforms necessary to perform the prescribed scan are produced and applied to the gradient system 124 that excites gradient coils in an assembly 128 to produce the magnetic field gradients Gₓ, G_{y}, and G_{z} used for position encoding MR signals. The gradient coil assembly 128 forms part of a magnet assembly 130 that includes a polarizing magnet 132 and a whole-body RF coil 134.

RF excitation waveforms are applied to the RF coil 134 by the RF system 126 to perform the prescribed magnetic resonance pulse sequence. Responsive MR signals detected by the RF coil 134 or a separate local coil (not shown in FIG. 1) are received by the RF system 126, amplified, demodulated, filtered and digitized under direction of commands produced by the pulse sequence server 118. The RF system 126 includes an RF transmitter for producing a wide variety of RF pulses used in MR pulse sequences. The RF transmitter is responsive to the scan prescription and direction from the pulse sequence server 118 to produce RF pulses of the desired frequency, phase and pulse amplitude waveform. The generated RF pulses may be applied to the whole body RF coil 134 or to one or more local coils or coil arrays (not shown in FIG. 1).

The RF system 126 also includes one or more RF receiver channels. Each RF receiver channel includes an RF amplifier that amplifies the MR signal received by the coil to which it is connected and a detector that detects and digitizes the I and Q quadrature components of the received MR signal. The magnitude of the received MR signal may thus be determined at any sampled point by the square root of the sum of the squares of the I and Q components:

M=\sqrt{I²+Q²},

and the phase of the received MR signal may also be determined:

$$φ = {tan}^{- 1} ( \frac{Q}{I} ) .$$

The pulse sequence server 118 also optionally receives patient data from a physiological acquisition controller 136. The controller 136 receives signals from a number of different sensors connected to the patient, such as ECG signals from electrodes or respiratory signals from a bellows. Such signals are typically used by the pulse sequence server 118 to synchronize, or “gate”, the performance of the scan with the subject's respiration or heart beat.

The pulse sequence server 118 also connects to a scan room interface circuit 138 that receives signals from various sensors associated with the condition of the patient and the magnet system. It is also through the scan room interface circuit 138 that a patient positioning system 140 receives commands to move the patient to desired positions during the scan.

The digitized MR signal samples produced by the RF system 126 are received by the data acquisition server 120. The data acquisition server 120 operates in response to instructions downloaded from the workstation 110 to receive the real-time MR data and provide buffer storage such that no data is lost by data overrun. In some scans the data acquisition server 120 does little more than pass the acquired MR data to the data processor server 122. However, in scans that require information derived from acquired MR data to control the further performance of the scan, the data acquisition server 120 is programmed to produce such information and convey it to the pulse sequence server 118. For example, during prescans MR data is acquired and used to calibrate the pulse sequence performed by the pulse sequence server 118. Also, navigator signals may be acquired during a scan and used to adjust RF or gradient system operating parameters or to control the view order in which k-space is sampled. And, the data acquisition server 120 may be employed to process MR signals used to detect the arrival of contrast agent in a magnetic resonance angiography (MRA) scan. In all these examples the data acquisition server 120 acquires MR data and processes it in real-time to produce information that is used to control the scan.

The data processing server 122 receives MR data from the data acquisition server 120 and processes it in accordance with instructions downloaded from the workstation 110. Such processing may include, for example: Fourier transformation of raw k-space MR data to produce two or three-dimensional images; the application of filters to a reconstructed image; the performance of a backprojection image reconstruction of acquired MR data; the calculation of functional MR images; the calculation of motion or flow images, etc.

Images reconstructed by the data processing server 122 are conveyed back to the workstation 110 where they are stored. Real-time images are stored in a data base memory cache (not shown) from which they may be output to operator display 112 or a display 142 that is located near the magnet assembly 130 for use by attending physicians. Batch mode images or selected real time images are stored in a host database on disc storage 144. When such images have been reconstructed and transferred to storage, the data processing server 122 notifies the data store server 123 on the workstation 110. The workstation 110 may be used by an operator to archive the images, produce films, or send the images via a network to other facilities.

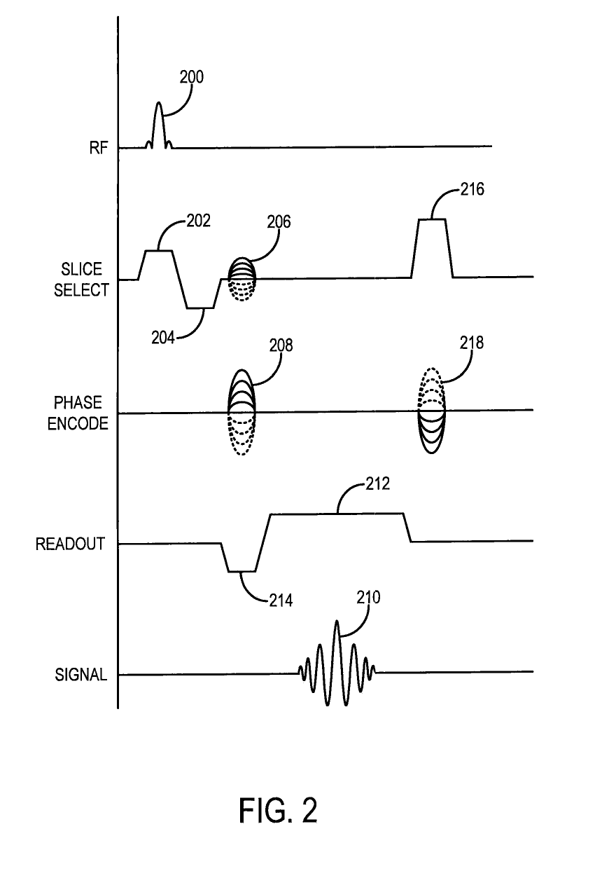

Referring particularly to FIG. 2, an exemplary pulse sequence for conducting a 3DFT NMR scan is shown. The pulse sequence commences by the selective excitation of the entire region of interest with an RF excitation pulse 200 in the presence of a slab select, for example, along the z-axis, G_{Z}, gradient pulse 202. The frequency content of the excitation pulse 200 and the amplitude of the slab select G_{z} pulse 202 are selected to produce transverse magnetization in the region that is the subject of the 3D scan. A negative G_{z} pulse 204 is then produced to rephase the spins in preparation for the phase encoding and readout.

Phase encoding is performed along two axes. Specifically, continuing from the axis conventions of the above example, the z-axis and the y-axis. The z-axis encoding is accomplished by applying a G_{z} phase encoding pulse 206 and the y-axis encoding is accomplished by applying a G_{y} phase encoding pulse 208. As is well-known to those skilled in the art, the magnitude of the phase encoding pulses 206 and 208 are stepped through a series of positive and negative values during the scan, but each is set to one value during each pulse sequence. As will be described in detail below, it is the order in which these phase encoding pulses 206 and 208 are stepped through their set of values that is a feature of the present invention. As is well-known in the art, the magnitude of a phase encoding gradient pulse is determined by the integral of its amplitude over its duration, that is, its area. In known pulse sequences the duration is kept constant and the phase encoding pulse magnitude is stepped through its values by changing its amplitude.

After phase encoding the transverse magnetization, the NMR signal 210 is read-out in the presence of a Gₓ read-out gradient 212. This read-out is preceded by a negative Gₓ gradient pulse 214 to produce the gradient refocused NMR echo signal 210 in the usual fashion. The 3DFT pulse sequence is then concluded by the application of a large G_{z} spoiler gradient pulse 216 and a G_{y} rewinder gradient pulse 218 to prepare the magnetization for the next pulse sequence, which follows immediately. As is known to those skilled in the art, the spoiler pulse 216 dephases transverse magnetization and the rewinder pulse 218 refocuses transverse magnetization along the y-axis in preparation for the next pulse sequence. The rewinder pulse 218 is equal in magnitude, but opposite in polarity with the G_{y} phase encoding pulse 208. It will be appreciated by those of ordinary skill in the art that residual transverse magnetization can alternatively be spoiled by adjusting the phase of the RF excitation pulse 200 from one cycle or repetition time period to the next.

The acquisition of data in 3DFT scanning can be considered sampling of a three-dimensional “k-space.” Two of the dimensions, in the above example, k_{y} and k_{z}, are sampled by applying different phase encoding gradients G_{y} and G_{z} during each pulse sequence of the scan, and each acquired NMR signal contains 256 samples along a line in the kₓ direction. The pulse sequence is repeated for as many repetitions as are necessary to sample all desired k_{y} and k_{z} values. For example, k_{y} may assume 128 different values and k may have 64 values. In this case, the number of repetitions of the pulse sequence of FIG. 2 would be 128-times-64, or 8192.

With conventional 3DFT scanning the desired values of k_{y} and k_{z} are sampled with two nested loops. For example, the inner loop increments k_{y} through its 128 values and after all such samples have been made for a given value of k_{z}, the outer loop increments k_{z}. This process continues until all 128 values of k_{y} have been sampled at each of the 64 values of k_{z}.

In general, to produce a time-of-arrival map the voxel locations, r, in a 3D volume-of-interest are analyzed. In particular, when a contrast agent is administered intravenously outside the volume-of-interest, each voxel in the volume initially has an average baseline signal intensity value. However, when the contrast agent arrives at a voxel location, r, the signal at that voxel location, r, is altered over time in accordance with the passage of the contrast agent. This information is utilized to assign an “arrival time” of the contrast agent at that voxel location, r. This process is repeated separately for all voxel locations, r, in the volume.

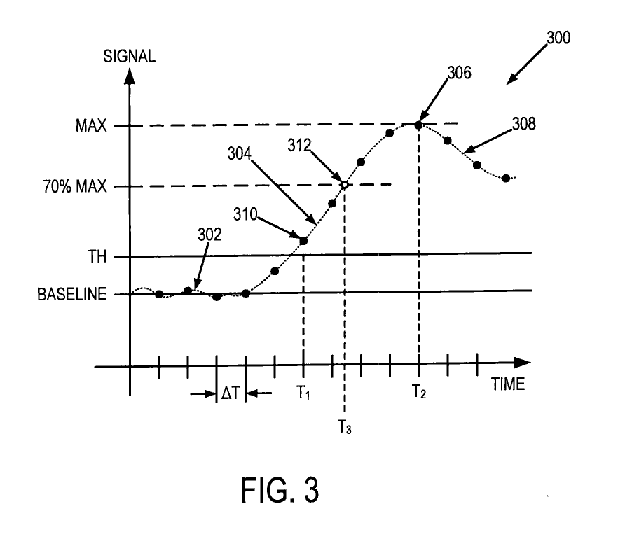

This process is further described referring particularly to FIG. 3, which is an exemplary plot of signal intensity 300 versus time for a hypothetical voxel location, r, in the 3D volume. Here, the time between image frames is ΔT. For the first several image frames, the signal intensity 300 is near baseline, such as indicated at 302. Any deviations from this baseline value are due to statistical uncertainty, that is to say, noise, in the measurements. Eventually the signal intensity 300 starts to rise, as indicated at 304, and continues to do so until it eventually reaches a maximum value, as indicated at 306, after which it gradually starts to decrease, as indicated at 308.

There several methods for assigning an arrival time to the set of signal intensity values shown, for example, in FIG. 3. One manner of selecting arrival time is by selecting the image frame, or corresponding time point at which the image frame is acquired, at which the measured signal intensity 300 first becomes larger than some threshold value, TH. For example, using the threshold value, TH, shown in FIG. 3, the arrival time for the voxel location, r, is selected as the time point T₁ (point 310). In the alternative, the maximum value 306 of the signal intensity 300 obtained at the voxel location, r, is determined. The time-of-arrival is then defined as either the time T₂ at which the signal intensity 300 attains the full maximum 306, or some percentage thereof, such as 70 percent. Of course, different percentages of the maximum signal intensity can be readily employed, as will be appreciated by those of ordinary skill in the art. In general, this percentage maximum does not occur at one of the actual sampled time points. Therefore, those time points whose respective signal values straddle the 70 percent maximum signal intensity value are selected, and the time-of-arrival is calculated by linear interpolation between these points. This interpolated time is shown as the interpolated point 312, which corresponds to a time point T₃. It should be appreciated by those skilled in the art that other definitions and methods for determining the time-of-arrival are also possible.

Once the particular method for determining time-of-arrival is selected, it is applied to all voxel locations, r, in the 3D volume. This results in a single 3D image for which the value assigned to every voxel is the determined time-of-arrival for that voxel location, r. This 3D image is then displayed to the clinician using various means.

To generate a time-of-arrival map in which the portrayed arrival time meaningfully represents the actual arrival time of contrast material in each voxel the image data acquisition strategy should be consistent; the central region of k-space should be compactly sampled; the duration of the acquisition time per image, also called the “temporal footprint,” should be minimized; and imaging artifacts should be substantially minimized. The manner in which each of these conditions are satisfied is described below.

First, for the image data acquisition strategy to be consistent the time ordering of how k-space is sampled within the data acquisition time is selected to be substantially the same for all image frames in the time series. That is to say, if the central portion of k-space is sampled early in the acquisition time for some first image, then it should be measured at the same relative time position for all subsequent images. This ensures, for example, that an object moving with linear velocity is portrayed as such in the resultant time series of MR image frames. The concept of consistency is described in detail, for example, by C. R. Haider, et al., in “3D High Temporal and Spatial Resolution Contrast-Enhanced MR Angiography of the Whole Brain,” Magnetic Resonance in Medicine, 2008; 60:749-760. In general, every image reconstructed in a 3D time series is formed from a set of k-space samples that are acquired over a given period of time. Images in such a time series of images are consistent if every image in the series has a substantially similar distribution of k-space samples during the period of time when the corresponding image data is acquired. For example, if a first image of the series uses central k-space samples that are acquired at a late phase in the temporal duration of data used to form that first image, then all images should have their respective central k-space samples formed from the same phase within the respective temporal durations of data collection for their formation.

For the central portion of k-space to be compactly sampled, the sampling therein is done in as short a time duration as possible. For a 3DFT acquisition, an elliptical centric view order, in which all central k-space encodes are measured contiguously in time, is employed. Exemplary elliptical centric view ordering methods are described, for example, by A. H. Wilman, et al., in “Fluoroscopically Triggered Contrast-Enhanced Three-Dimensional MR Angiography with Elliptical Centric View Order: Application to the Renal Arteries,” Radiology, 1997; 205:137-146.

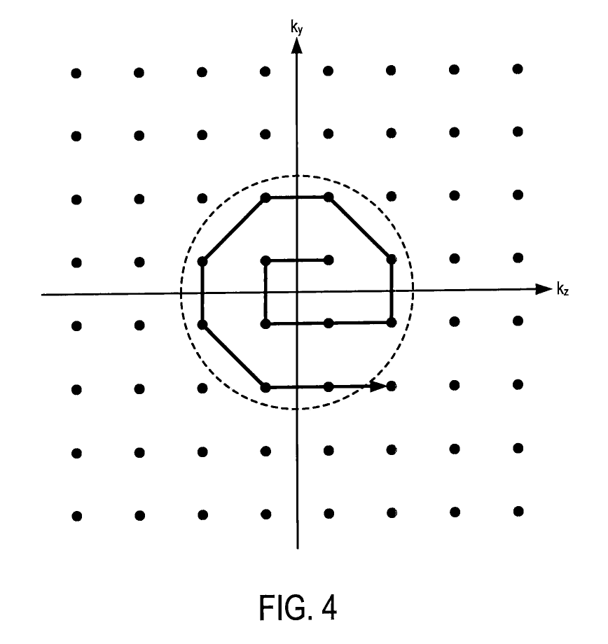

Centric view ordering is based on the realization that, for most objects, the bulk of the signal power is contained in the samples taken near the origin of (k_{y}, k_{z}) space, and it is these samples that contribute most significantly to the appearance of the reconstructed image. This results from the fact that the NMR signals acquired during the scan are Fourier transformed along the kₓ, k_{y} and k_{z} directions to produce intensity values for an image in real space. It is the nature of this transformation that the samples near the origin (k_{y}=0, k_{z}=0) contribute a disproportionate share to the signal power of the reconstructed image. Accordingly, it is a basic idea of centric view ordering to sample the (k_{y}, k_{z}) points that contain the most signal power in as short a time and as close to the beginning of the scan as possible. This can be done by modifying the trajectory with which the (k_{y}, k_{z}) space is sampled. For example, an elliptical spiral (k_{y}, k_{z}) trajectory, such as that shown in FIG. 4 is used. The scan starts at or near the origin of (k_{y}, k_{z}) space and progressively works its way outward in a spiral fashion. In FIG. 4, an 8-by-8 array of k-space samples is shown; however, this is only illustrative, since in practice many more samples are usually acquired to cover the field of view with adequate resolution. The manner in which the values of the G_{y} and G_{z} phase encoding gradients are stepped to accomplish a spiral trajectory scan is described, for example, in U.S. Pat. No. 5,122,747.

In the alternative, image data can be acquired using a so-called projection reconstruction (“PR”) acquisition, in which k-space is sampled by a series of radial projections that extend outward from the center of k-space. However, PR-based data acquisition schemes sample the central portion of k-space with every radial projection; therefore, rather than freeze object motion or status within a fixed duration within the acquisition time, as with centric ordering in 3DFT acquisition, this effect in PR data acquisitions causes the object status in the image to be a blurred version representative of the entire image acquisition time. To minimize any blurring due to the advancement of the contrast agent bolus during the acquisition time for an image, the image acquisition time should be minimized. This can done using various acceleration techniques such as 2D SENSE.

Artifact ridden signals can result from many possible sources in MRI. For accurate time-of-arrival mapping, it is desirable that any signal assigned to a vessel is done so only after contrast material has already arrived at that vessel. Signal assigned to a vessel prior to actual contrast arrival is referred to as a so-called “anticipation” artifact. This artifact can occur if k-space samples used to generate the image ascribed to some time point are measured at times later than that time point. For accurate time-of-arrival mapping it is desirable to have no anticipation artifact. If anticipation artifacts are unavoidable, it is desirable that the level of artifact be limited spatially so that the leading edge of the contrast agent passage is not artifactually extended, and the time-of-arrival is not assigned as occurring earlier than it actually does. Anticipation artifacts can be substantially suppressed if the central portion of k-space is sampled toward the end of the temporal duration of data acquisition for a given image frame.

In a typical 3D volume containing a vascular bed the vast majority of voxels are located within non-vascular materials such as soft tissue, fat, and bone. It may not be meaningful to attempt to define a time-of-arrival of contrast material for these structures. Further, to attempt to portray the time-of-arrival for these materials may confound the presentation of the time-of-arrival values in the actual vascular structures. To avoid this, it is desirable to not portray the time-of-arrival for these non-vascular structures. This can be done in various ways. For example, the time series of image frames can be utilized to produce a series of difference images, in which the images portraying the transit of contrast are each subtracted from a non-contrast enhanced time series of image frames acquired beforehand. In this case the background materials will show very little enhancement. Thus, one straightforward way to exclude such voxels from being displayed is to apply a threshold on the difference images. If the difference signals at a specific voxel do not exceed the threshold, then the time-of-arrival determined for that voxel is excluded from being portrayed in the display.

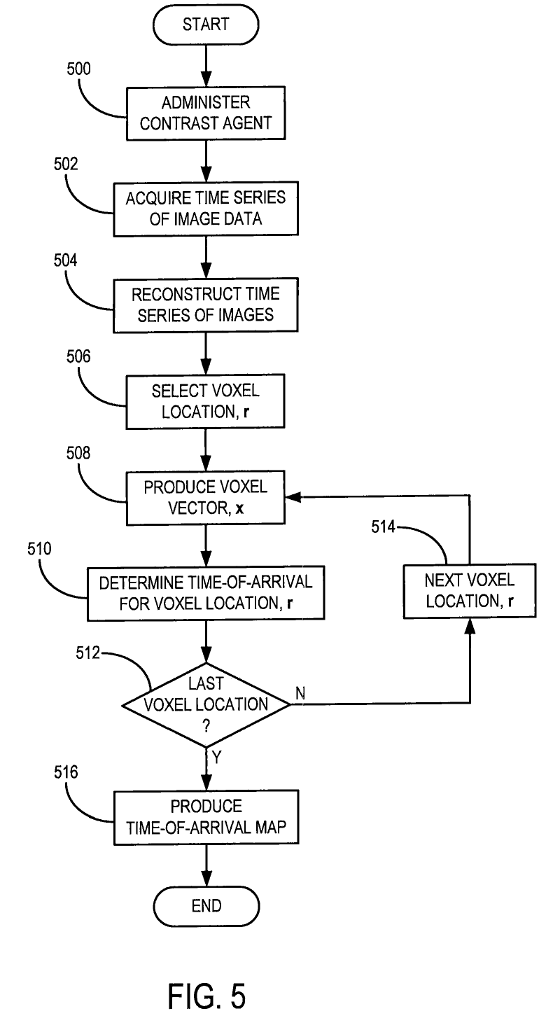

Referring particularly now to FIG. 5, the steps of an exemplary method for producing a time-of-arrival map in accordance with the present invention are illustrated. The method begins with the administration of a contrast agent to the subject, as indicated at step 500. As the contrast agent passes through a tissue of interest in the subject, a time series of image data is acquired, as indicated at step 502. Image data is acquired using, for example, a 3DFT GRE pulse sequence, such as the one shown in FIG. 2. Subsequently, a corresponding time series of image frames are reconstructed from the acquired time series of image data, as indicated at step 504. The time series of image frames includes a plurality of images indicative of the same volume-of-interest in the subject, which contains the tissue of interest through which the contrast agent passes. This volume-of-interest occupies the same field-of-view throughout the time series; therefore, a voxel location in the first image frame in the time series will correspond to the same voxel location in any subsequent image frame in the time series. These images are time-resolved, in that they depict the passage of the contrast agent through the tissue of interest over the duration of the data acquisition period.

Alternatively, one or more image frames are produced from a time series of image data acquired before the administration of the contrast agent or the arrival of contrast agent within the volume of interest. One of these “pre-contrast” image frames is then subtracted from each image frame in the post-contrast time series in order to produce a time series of difference images. These difference images have substantially suppressed image intensity in voxel locations corresponding to background tissue. In this manner, the subsequent determination of the time-of-arrival for each voxel location is made more efficient, since those voxels not corresponding to any vasculature are effectively removed from the succeeding analysis.

After the time series of image frames has been reconstructed, a voxel location, r, is selected for analysis, as indicated at step 506. Using this voxel location, r, a voxel vector, x, is produced, as indicated at step 508. This voxel vector, x, is produced from all of the voxels in the time series of image frames having the same voxel location, r. Thus, the voxel vector, x, is indicative of the signal change over time at the voxel location, r, and has a length, N, where N is the number of time points in the time series. An exemplary voxel vector has the form:

x=[x₁ x₂ . . . x_{N}];

where xₙ is the image intensity value at the voxel location, r, corresponding to the voxel vector, x, at the n^{th} time point in the time series of image frames. More specifically, the n^{th} “time point” in the time series of image frames corresponds to the n^{th} image frame in that time series. From this voxel vector, x, a time-of-arrival is determined at the corresponding voxel location, r, as indicated at step 510. Two exemplary methods for determining the time-of-arrival are described below in detail. A determination is then made as to whether all of the desired voxel locations, r, have been processed, as indicated at decision block 512. If not, a next voxel location, r, is selected at step 514 and the time-of-arrival for that location is determined as described above with respect to steps 508 and 510.

Once the time-of-arrival is determined for each voxel location, r, in the image volume, an image indicative of the time-of-arrival of the contrast agent at each voxel location, r, is produced, as indicated at step 516. Such a “time-of-arrival map” is produced, for example, by converting each determined time-of-arrival value to a grayscale image intensity value. For example, the earliest arrival times are encoded in black and the latest times in white, with intermediate values encoded with an appropriate shade of gray from a grayscale color spectrum. In the alternative, however, the early arrival times can be encoded in deep red and late arrival times in deep blue, with a color spectrum of red-to-blue used for intermediate time-of-arrival values. In general, it is contemplated that any color spectrum can be employed to map the time-of-arrival image intensity values to corresponding colors in order to display the times-of-arrival in an appropriate manner.

A time-of-arrival map produced in the foregoing manner can help to distinguish arterial from venous structures. The production of a time-of-arrival map in the foregoing manner provides significant versatility. For example, another option when producing the time-of-arrival map is to apply a “time window” to the determined time-of-arrival values. In this manner, only times-of-arrival that fall within the two endpoints of the selected time window are encoded in the time-of-arrival map, while those voxel locations, r, whose corresponding time-of-arrival falls outside of the time window are assigned a zero value in the resultant time-of-arrival map and, therefore, effectively not displayed. Such a time-windowed, time-of-arrival map is useful for isolating arterial and venous blood flow and, thereby, producing images substantially containing only arteries or veins, respectively.

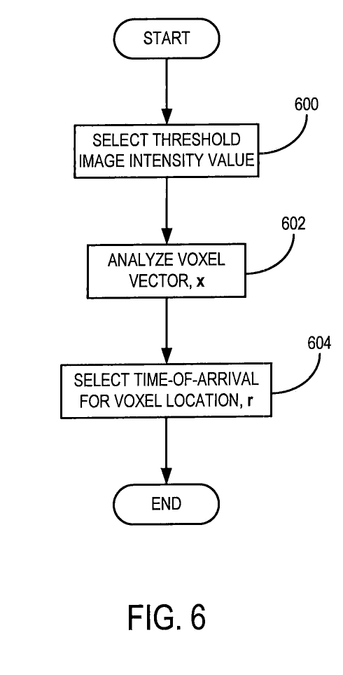

Referring now to FIG. 6, the steps of an exemplary method for determining the time-of-arrival of a contrast agent from a voxel vector is illustrated. In this method, a threshold signal intensity value is selected first, as indicated at step 600. The image intensity values in the voxel vector, x, are then analyzed with respect to the threshold value, as indicated at step 602. When an image intensity value above the selected threshold value is detected, the corresponding “time point,” is recorded as the time-of-arrival for the corresponding voxel location, r, as indicated at step 604. In particular, the time at which the corresponding image frame was acquired is selected as the time-of-arrival. This time value is measured from the administration of the contrast agent to the subject, which is assigned a zero time value.

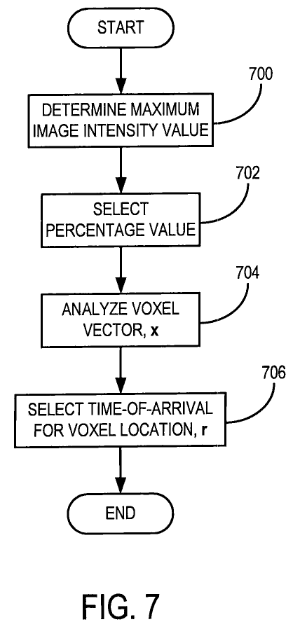

Referring now to FIG. 7, the steps of another exemplary method for determining the time-of-arrival of a contrast agent from a voxel vector is illustrated.

In this method, the voxel vector, x, is first analyzed to determine the maximum image intensity value therein, as indicated at step 700. A percentage value is then selected, as indicated in step 702. Following this selection, the image intensity values in the voxel vector, x, is again analyzed with respect to the percentage of the maximum image intensity, as indicated at step 704. The percentage of the maximum image intensity is determined by applying the selected percentage value to the determined maximum image intensity value. Exemplary percentage values include 30, 70, and 100 percent; however, any appropriate percentage can be similarly employed. It is not unlikely that the exact time point corresponding to the percentage maximum occurs between two entries in the voxel vector, x. In this situation, an interpolation between the two image intensity values that surround the percentage maximum value is performed. In this manner, a time point corresponding to this percentage maximum value is more accurately determined. By the foregoing analysis of the voxel vector, x, a time-of-arrival for the corresponding voxel vector, x, is determined and recorded, as indicated at step 706. As indicated above, the time at which the corresponding image frame was acquired is selected as the time-of-arrival. However, when interpolation between time points is utilized, it is this time value that is selected as the time-of-arrival. Again, the time value is measured from the administration of the contrast agent to the subject, which is assigned a zero time value.

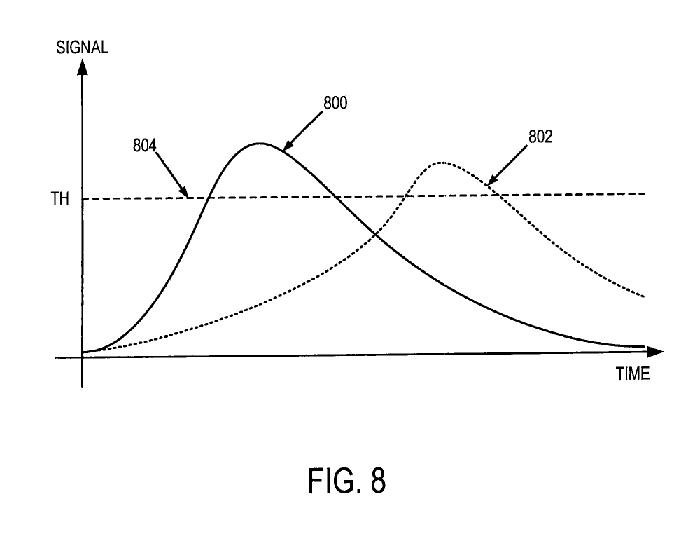

By way of example, and referring now to FIG. 8, the passage of a contrast agent through a subject's arteries produces a signal intensity change in a given voxel corresponding to the arterial curve 800. Similarly, the passage of the contrast agent through the subject's veins produces a signal intensity change in a different voxel location corresponding to the venous curve 802. Since these two curves may overlap for a period of time, it can become difficult to discriminate between arterial and venous vasculature in images produced by conventional contrast-enhanced MR angiography methods. However, when employing the aforementioned method for producing a time-of-arrival map, this problem is alleviated.

By way of further example, using the threshold method for determining the time-of-arrival that is described above with respect to FIG. 6, it can be seen that those voxel locations corresponding to arteries have a time-of-arrival significantly earlier than those corresponding to veins. This point is illustrated by the intersection of a threshold line 804 with the arterial and venous curves, 800 and 802, respectively. As a result, the corresponding times-of-arrival will be encoded differently when producing the time-of-arrival map. For example, when a red-to-blue encoding scheme is employed, those voxel locations corresponding to arteries will appear as red in the time-of-arrival map, while those corresponding to veins will appear as blue. This provides an image that allows much simpler discernability between arteries and veins. Moreover, using the same time series of images, and the same set of determined times-of-arrival, multiple images of the subject's vasculature can be produced. As described above, one arterial time-of-arrival map corresponding to the subject's arteries can be produced using a time window that excludes later occurring times-of-arrival. Additionally, a second venous time-of-arrival map can be produced using a time window that excludes earlier occurring times-of-arrival.

In addition to the method described above, further enhancement of the produced time-of-arrival map is achievable by utilizing an image containing fixed anatomical information representative of the same volume-of-interest, or field-of-view, that the time-of-arrival map represents. For example, an image of the bone structures within the volume-of-interest can be produced and combined with the time-of-arrival map. This may facilitate the visualization of the relative positions of vascular structures with respect to boney landmarks. Such an image is particularly useful for surgical planning. Images of the reference structures may be determined either from the original time series of images used to produce the time-of-arrival maps, or from a separate set of images that are acquired and subsequently registered with the time-of-arrival maps.

The present invention has been described in terms of one or more preferred embodiments, and it should be appreciated that many equivalents, alternatives, variations, and modifications, aside from those expressly stated, are possible and within the scope of the invention.

1. A method for producing, with a magnetic resonance imaging (MRI) system, an image indicative of the passage of a contrast agent through a tissue of interest in a subject, the steps comprising:
a) acquiring, with the MRI system, a time series of image data during the passage of the contrast agent through the tissue of interest;
b) reconstructing from the time series of image data, a time series of image frames;
c) determining, using the reconstructed time series of image frames, a time-of-arrival of the contrast agent in the tissue of interest at each voxel location in a field-of-view shared by the reconstructed time series of image frames; and
d) producing an image by assigning an image intensity value to each voxel location, the image intensity value corresponding to the determined time-of-arrival at each respective voxel location.

2. The method as recited in claim 1 in which step c) includes forming a voxel vector for each voxel location in the field-of-view by concatenating image intensity values at the voxel location from each image frame in the time series of image frames.

3. The method as recited in claim 2 in which step c) further includes selecting a threshold image intensity value and analyzing each voxel vector using the selected threshold.

4. The method as recited in claim 3 in which step c) further includes determining a time point in the time series of image frames at which the image intensity at the selected voxel location rises above the selected threshold image intensity value.

5. The method as recited in claim 3 in which step c) further includes determining a time point in the time series of image frames at which the image intensity at the selected voxel location is equal to the selected threshold image intensity value.

6. The method as recited in claim 1 in which step d) includes mapping a color scale to the image intensity values.

7. The method as recited in claim 6 in which the color scale includes at least one of a grayscale and a red-to-blue color scale.

8. The method as recited in claim 1 in which step a) includes sampling a central portion of k-space in a centric order.

9. The method as recited in claim 8 in which the centric order is an elliptical centric view order.

10. The method as recited in claim 1 in which step d) includes selecting a time window, and the image is produced by assigning nonzero image intensity values only to voxel locations having a time-of-arrival that occurred within the selected time window and assigning a zero image intensity value to those voxel locations having a time-of-arrival that did not occur within the selected time window.

11. The method as recited in claim 1 further including:
acquiring, with the MRI system, a time series of pre-contrast image data before the passage of the contrast agent through the tissue of interest; and
reconstructing, from the time series of pre-contrast image data, a time series of pre-contrast image frames.

12. The method as recited in claim 11 further including producing a time series of difference images by subtracting the time series of image frames and the time series of pre-contrast image frames.

13. The method as recited in claim 12 in which step c) includes determining the time-of-arrival of the contrast agent in the tissue of interest at each voxel location in the field-of-view shared by the series of difference images.

14. The method as recited in claim 11 in which the time series of pre-contrast image data is acquired before step a) is performed.
